(19) United States
(12) Patent Application Publication
(10) Pub. No.: US 2006/0211557 A1
(43) Pub. Date: Sep. 21, 2006

(54) Method and feed unit for feeding collars to a packing line for producing rigid packages

(75) Inventors: Stefano Rimondini, Bologna (IT); Stefano Negrini, Calderara Di Reno (IT)

Correspondence Address: MARSHALL, GERSTEIN & BORUN LLP, 233 S. WACKER DRIVE, SUITE 6300, SEARS TOWER, CHICAGO, IL, 60606, US

(73) Assignee: G.D SOCIETA' PER AZIONI, Bologna (IT)

(21) Appl. No.: 11/384,700

(22) Filed: Mar. 20, 2006

(30) Foreign Application Priority Data
Mar. 21, 2005 (IT) BO2005A 000174

(51) Int. Cl. B31B 1/14; B31B 1/88

(52) U.S. Cl. 493/54; 493/56

(57) ABSTRACT

A method and unit for feeding collars to a packing line for producing rigid packages, whereby a web is fed in a longitudinal feed direction and through a first cutting station where the web is cut partly along a portion of a parting line crosswise to the feed direction; the web is then fed through a second cutting station where each collar is detached from the web along the parting line, and is then fed to the packing line; at the second cutting station, each collar is detached from the web by cutting along the remaining portion of the parting line not cut at the first cutting station. (FIG. 1)

The present invention relates to a method and feed unit for feeding collars to a packing line for producing rigid packages.

The present invention is particularly advantageous for use on a packing line for producing rigid, hinged-lid packets of cigarettes, to which the following description refers purely by way of example.

### BACKGROUND OF THE INVENTION

A rigid, hinged-lid cigarette packet comprises a cup-shaped container having an open top end; and a cup-shaped lid hinged to the container along a hinge to rotate, with respect to the container, between an open position and a closed position opening and closing the open end respectively. A rigid, hinged-lid cigarette packet is normally produced by folding a single flat, substantially elongated rectangular blank about a group of cigarettes wrapped in a sheet of foil.

A collar, separate from the flat blank, is also normally provided, and is fitted, folded into a U, inside the container to project partly outwards of the open end and engage a corresponding inner surface of the lid when the lid is in the closed position. The function of the collar is to keep the lid in the closed position by requiring the application of a certain amount of force to open the lid; for which purpose, the collar preferably comprises two projections, which project outwards to engage the lid with a given amount of interference when the lid is in the closed position.

Packing machines for producing rigid packets of cigarettes are known to feature packing lines comprising a pocket conveyor, which feeds groups of cigarettes, already enclosed in respective protective foil wrappings, through a collar feed station.

The collars are normally fed to the feed station by a cutting device, which separates the individual collars by transversely cutting a cardboard web along a transverse parting line. Before reaching the cutting device, the cardboard web is creased along longitudinal fold lines, and is cut to define the outward projections. In a typical embodiment, the cutting device comprises an anvil having a face coplanar with the web; and a knife movable to and from the anvil to cut the collars. A suction head on a transfer wheel picks up each collar cut off the web, and feeds the collar onto the respective group of cigarettes on the packing line pocket conveyor.

Patent Application EP 1013557A1 describes a unit for feeding collars to a continuous packing line for producing rigid packets of cigarettes. At a cutting station, a continuous web is cut by a knife into a succession of collars, which are picked up continuously by respective gripping members, each of which is oscillated with the knife to grip the collar, just cut off the web, between the knife and the gripping member.

Patent U.S. Pat. No. 5163268A1 describes feeding collars to a cigarette packing machine for producing rigid, hinged-lid packets. A packing wheel on a packing line of the packing machine is associated with a feed device, by which the collars are fed successively to the packing wheel onto the outer surfaces of respective groups of cigarettes already on the wheel.

Patent GB 1536026B describes producing collars on a cigarette packing machine for producing rigid, hinged-lid packets. The collars are obtained by feeding a cardboard web in steps along a straight path; making longitudinal cuts on the cardboard web; and cutting the collars transversely off the web. The longitudinal cuts are made by cutting rollers cooperating with elastically-supported counter-rollers.

As will be clear from the foregoing description, each collar is detached from the web by cutting along a transverse parting line, which defines the top transverse edge of one collar and the bottom transverse edge of the next collar. In view of the fact that the top transverse edge of the collar is one of the most visible parts of a rigid packet of cigarettes when the packet of cigarettes is opened, achieving a high-quality cut along the parting line is extremely important.

The above methods of feeding collars to a packing line are effective and efficient when working with a highly linear parting line between each collar and the web. Some situations, however, call for a parting line, particularly the central portion of it, of highly complex, articulated shape; in which case, the above methods of feeding collars to a packing line only permit a good-quality cut at very low operating speeds.

### SUMMARY OF THE INVENTION

It is an object of the present invention to provide a method and feed unit for feeding collars to a packing line for producing rigid packages, and which are designed to eliminate the aforementioned drawbacks, while at the same time being cheap and easy to implement.

According to the present invention, there are provided a method and feed unit for feeding collars to a packing line for producing rigid packages, as claimed in the attached Claims.

### BRIEF DESCRIPTION OF THE DRAWINGS

A non-limiting embodiment of the present invention will be described by way of example with reference to the accompanying drawings, in which:

FIG. 1 shows a schematic front view of part of packing machine featuring the collar feed unit according to the present invention;

FIG. 2 shows a front view in perspective of a rigid packet of cigarettes produced on the FIG. 1 packing machine;

FIG. 3 shows a plan view of an unfolded collar of the FIG. 2 packet of cigarettes;

FIG. 4 shows a portion of a web from which the FIG. 3 collar is detached;

FIGS. 5 and 6 show a cutting device of the FIG. 1 feed unit in two different successive operating positions.

### DETAILED DESCRIPTION OF THE INVENTION

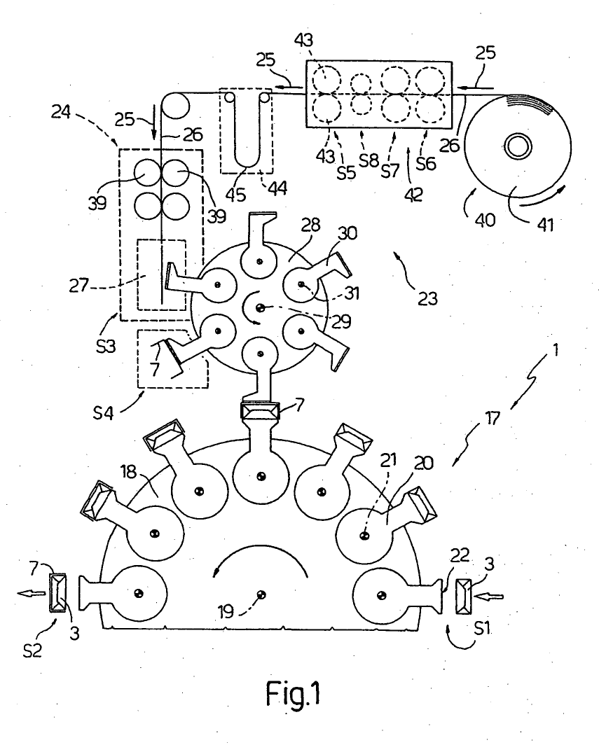

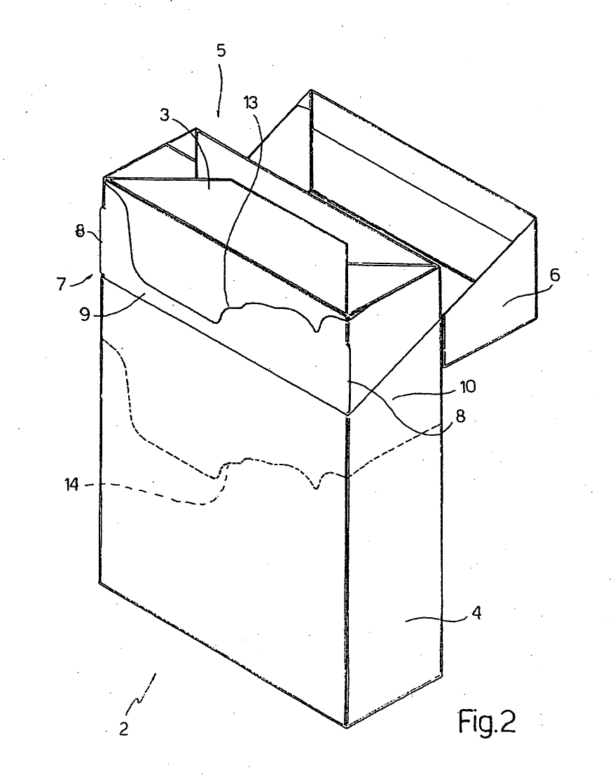

Number 1 in FIG. 1 indicates as a whole an automatic packing machine for producing rigid packets 2 of cigarettes (one of which is shown in FIG. 2).

As shown in FIG. 2, each packet 2 contains a parallelepiped-shaped group 3 of cigarettes wrapped in a sheet of foil packing material, which sheet of packing material has a tear-off top portion (not shown in detail). Each packet 2 comprises a cup-shaped container 4 housing the orderly group 3 of cigarettes, and having an open top end 5; and a cup-shaped lid 6 hinged to container 4 to rotate, with respect to container 4, between an open position (FIG. 2) and a closed position (not shown) opening and closing open top end 5 respectively.

A U-folded collar 7 is glued to the inside of each container 4, and projects partly outwards from open top end 5 to engage a corresponding inner surface of lid 6 when lid 6 is in the closed position. The function of collar 7 is to keep lid 6 in the closed position by requiring the application of a certain amount of force to open lid 6; for which purpose, collar 7 preferably comprises two projections 8, which project outwards to engage lid 6 with a given amount of interference when lid 6 is in the closed position.

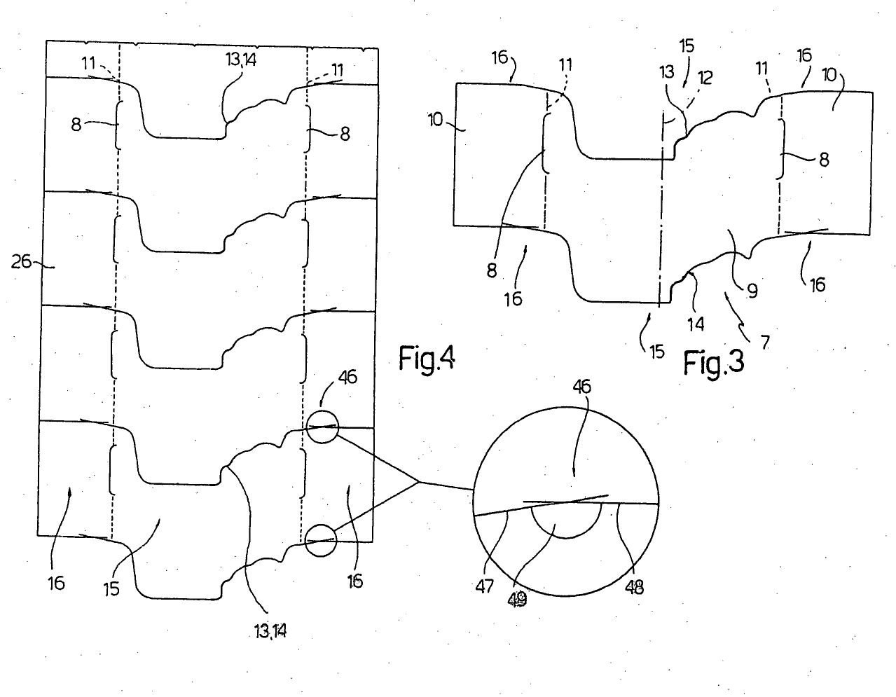

As shown in FIG. 3, each collar 7 comprises a central panel 9; and two lateral wings 10 located on opposite sides of central panel 9 and connected to central panel 9 along respective longitudinal fold lines 11. Longitudinal fold lines 11 extend crosswise to a major dimension of collar 7 and parallel to a longitudinal axis of symmetry 12 of collar 7. Collar 7 has a top transverse edge 13 and a bottom transverse edge 14, which are parallel to each other and extend crosswise to longitudinal axis of symmetry 12. More specifically, top transverse edge 13 comprises a central portion 15, and two lateral portions 16 offset with respect to central portion 15; lateral portions 16 are linear in shape, while central portion 15 is of complex, articulated shape.

As shown in FIG. 1, packing machine 1 comprises a packing line 17 (shown only partly in FIG. 1) along which a succession of groups 3 of cigarettes are wrapped in respective sheets (not shown) of foil packing material. A collar 7 is then folded into a U about each group 3 of cigarettes wrapped in a sheet of foil packing material; and a blank (not shown) is then folded about group 3 of cigarettes wrapped in a sheet of foil packing material, and on top of collar 7 to define container 4 and lid 6.

FIG. 1 shows partly a packing wheel 18, which forms part of packing line 17, rotates about a central axis of rotation 19 perpendicular to the FIG. 1 plane, and has a number of heads 20 equally spaced along the periphery of packing wheel 18. Each head 20 is hinged to packing wheel 18 to rotate, with respect to packing wheel 18 and under the control of a cam system (not shown), about an axis of rotation 21 parallel to axis of rotation 19; and the free end of each head 20 supports a pocket 22 for receiving a group 3 of cigarettes, wrapped in a sheet of foil packing material, at an input station S1, and for releasing group 3 of cigarettes at an output station S2. A feed unit 23, for feeding collars 7 successively to groups 3 of cigarettes conveyed by pockets 22, is located between input station S1 and output station S2.

Feed unit 23 comprises a conveying device 24 for feeding a web 26 of cardboard in steps and in a vertical feed direction 25 to a cutting station S3, where a cutting device 27 engages web 26 to form, from web 26, a succession of collars 7 positioned with their longitudinal axis of symmetry 12 parallel to feed direction 25. More specifically, cutting device 27 of cutting station S3 detaches each collar 7 from web 26 along a parting line 13, 14 substantially crosswise to feed direction 25 and defining both the top transverse edge 13 of one collar 7, and the bottom transverse edge 14 of the next collar 7. Feed unit 23 also comprises a transfer wheel 28 mounted on a fixed support (not shown) to rotate about an axis of rotation 29 parallel to axis of rotation 19 of packing wheel 18.

Transfer wheel 28 picks up each collar 7 individually from cutting station 27, feeds collar 7 through a folding station S4 where lateral wings 10 of collar 7 are folded squarely with respect to relative central panel 9, and then feeds the U-folded collar 7 to a group 3 of cigarettes conveyed by a pocket 22 of packing wheel 18. Transfer wheel 28 has a number of suction gripping heads 30 equally spaced along the periphery of transfer wheel 28 and extending outwards to each transfer a respective collar 7 from cutting station S3 to packing wheel 18. Each suction gripping head 30 is hinged to transfer wheel 28 to rotate, with respect to transfer wheel 28 and under the control of a cam system (not shown), about an axis of rotation 31 parallel to axis of rotation 29.

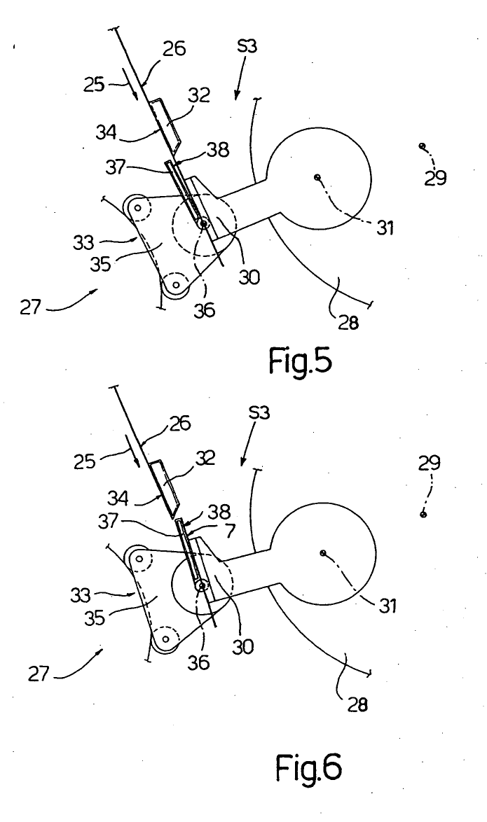

As shown in FIGS. 5 and 6, cutting device 27 comprises an anvil 32 and a movable cutting member 33 located successively in feed direction 25 of web 26. Anvil 32 is fixed, and has a face 34 positioned contacting web 26 and having a cutting edge at the end facing cutting member 33. Cutting member 33 comprises a plate 35 located downstream from anvil 32 in feed direction 25, and mounted to rotate about a respective axis of oscillation 36 parallel to axis of rotation 29 and coplanar with face 34. Plate 35 is fitted integrally with a knife 37 having a surface 38 facing the periphery of transfer wheel 28. At its free end facing anvil 32, surface 38 has a cutting edge complementary to the cutting edge of anvil 32; and knife 37 oscillates with plate 35, with respect to anvil 32, to cut a collar 7 off web 26 for each complete back and forth oscillation about axis of oscillation 36.

As shown in FIG. 1, conveying device 24 for conveying web 26 comprises a number of pairs of counter-rotating rollers 39 located successively in feed direction 25. Each pair of rollers 39 comprises two rollers 39 located on opposite sides of web 26 and mounted for rotation to feed web 26 in steps in feed direction 25 to cutting station S3; in each pair of rollers 39, one roller 39 is preferably an idle pressure roller, and the other roller 39 is a powered roller.

Feed unit 23 also comprises an unwinding device 40 for unwinding web 26 off a reel 41; and a work area 42 located upstream from cutting station S3 and comprising a further cutting station S5 defined by a pair of counter-rotating rollers 43, between which web 26 is fed. One roller 43 comprises a number of knives (not shown) arranged along its lateral surface, and the other roller 43 comprises a number of anvils (not shown) which cooperate with the knives to cut web 26.

In a preferred embodiment, work area 42 comprises a creasing station S6 where web 26 is creased longitudinally to define the two longitudinal fold lines 11; and an incision station S7 where web 26 is cut at longitudinal fold lines 11 to form laterally-projecting projections 8. In one possible embodiment, work area 42 also comprises a printing station S8 where one surface of web 26 is printed.

Between work area 42 and cutting station S3, a compensating device 44 is provided, in which web 26 forms a loop 45 of variable length to permit step feed of web 26 downstream from compensating device 44 (i.e. at cutting station S3), and constant-speed feed of web 26 upstream from compensating device (i.e. at work area 42).

Operation of feed unit 23 described above will now be described in detail.

In actual use, web 26 is unwound off reel 41 and fed at substantially constant speed through work area 42. FIG. 4 shows a portion of web 26 immediately downstream from work area 42. The two longitudinal fold lines 11 are defined at creasing station S6; laterally-projecting projections 8 are then defined at incision station S7; and, finally, web 26 is cut along a central portion 15 of each parting line 13, 14 at cutting station S5. In other words, web 26 is only cut partly along each parting line 13, 14 at cutting station S5, so that, downstream from cutting station S5, collars 7 are still joined to one another in the form of web 26.

At cutting station S3, cutting device 27 then cuts the remaining lateral portions 16 of parting line 13, 14 not cut at cutting station S5, to detach each collar 7 from web 26. In other words, cutting station S5 partly cuts each parting line 13, 14 along central portion 15, and cutting station S3 completes the cut along each parting line 13, 14 by cutting the remaining lateral portions 16 of parting line 13, 14 not cut at cutting station S5, to detach each collar 7 from web 26. This is achieved by appropriately shaping the cutting members of cutting station S3 and cutting station S5. That is, the cutting members of cutting station S3 are shaped to only cut lateral portions 16 of parting line 13, 14, while the cutting members of cutting station S5 are shaped to only cut central portion 15 of parting line 13, 14.

To detach a collar 7 from web 26, conveying device 24 feeds web 26 one step in feed direction 25 to cutting station S3, so that a length of web 26 equal to a collar 7 projects beyond the cutting edge of anvil 32 and beneath knife 37, which is in a rest position over web 26. At the same time, transfer wheel 28 feeds a respective suction gripping head 30 to cutting station S3, so that gripping head 30 is positioned contacting plate 35 to grip collar 7 against plate 35. At this point, plate 35 and gripping head 30 are oscillated together in substantially identical movements. Collar 7 is thus detached from web 26 by cutting lateral portions 16 of parting line 13, 14 not cut at cutting station S5.

In a preferred embodiment shown in FIG. 4, at the border area 46 between central portion 15 cut at cutting station S5 and lateral portions 16 cut at cutting station S3, the cutting line 47 of cutting station S5 slopes with respect to the cutting line 48 of cutting station S3, so that cutting line 48 of cutting station S3 intersects cutting line 47 of cutting station S5 to form an obtuse angle 49. This is an important characteristic, by enabling the position tolerances of cutting line 47 of cutting station S5 and of cutting line 48 of cutting station S3 to be recovered completely without impairing the appearance of collars 7 in any way. That is, any variations in the position of cutting line 47 of cutting station S5 with respect to the position of cutting line 48 of cutting station S3 simply result in a slight shift, unnoticeable by the user of packets 2 of cigarettes, in the point of intersection between the two cutting lines 47 and 48. It should be pointed out that any flaw, of the type shown in FIGS. 3 and 4, along bottom transverse edge 14 of collar 7 is totally irrelevant, since, in a rigid packet 2 of cigarettes, the portion of collar 7 close to bottom transverse edge 14 is completely concealed.

In the FIG. 1 embodiment, reel 41, into which web 26 is wound, is mounted on packing machine 1; and web 26 is then wound off reel 41, fed through work area 42 comprising cutting station S5, and then fed to cutting station S3. In a different embodiment not shown, web 26 is fed through cutting station S5 and then wound into reel 41; reel 41 is then mounted on packing machine 1, and web 26 is unwound off reel 41 and fed to cutting station S3. In other words, cutting station S5 may be mounted on or off packing machine 1.

Feed unit 23 as described above is highly effective and efficient even at high operating speeds, and regardless of whether parting line 13, 14 between each collar 7 and web 26 is linear or complex and articulated in shape. In particular, high-quality cutting of web 26 is achieved at all times, even when dealing with a complex, articulated parting line 13, 14. This is achieved by dividing cutting of web 26 along each parting line 13, 14 into two successive steps, and therefore between two successive cutting stations S3, S5. At cutting station S5, web 26 is simply cut as best as possible along central portion 15 of each parting line 13, 14, with no need to grip the cut collar 7, which, only being cut partly, remains attached to web 26. At cutting station S3, since only the lateral portions 16 of parting line 13, 14 are to be cut, each collar 7 can be gripped immediately in the middle, thus simplifying the cutting operation by ensuring the position of collar 7 beforehand.

In view of its numerous advantages, feed unit 23 as described above may be used on a packing line for producing any type of rigid package featuring a collar, such as a carton of cigarettes, a packet of cigars, or a box of confectionary.

1) A method of feeding collars to a packing line for producing rigid packages; the method comprising the steps of:
feeding a web (26) in a longitudinal feed direction (25) and through a first cutting station (S5);
partly cutting the web (26), at the first cutting station (S5), along a portion (15) of a parting line (13, 14) substantially crosswise to the feed direction (25);
feeding the web (26) through a second cutting station (S3) downstream from the first cutting station (S5);
at the second cutting station (S3), detaching each collar (7) from the web (26) along the respective parting line (13, 14) by cutting along the remaining portion (16) of the parting line (13, 14) not cut at the first cutting station (S5); and
feeding each collar (7), detached from the web (26), to the packing line (17).

2) A method as claimed in claim 1, wherein, at the first cutting station (S5), the web (26) is cut along a central portion (15) of each parting line (13, 14); and, at the second cutting station (S3), the remaining lateral portions (16) of the parting line (13, 14) not cut at the first cutting station (S5) are cut to detach each collar (7) from the web (26).

3) A method as claimed in claim 2, wherein, for each parting line (13, 14), at the border area (46) between the central portion (15) cut at the first cutting station (S5) and the lateral portions (16) cut at the second cutting station (S3), the cutting line (47) of the first cutting station (S5) slopes with respect to the cutting line (48) of the second cutting station (S3), so that the cutting line (48) of the second cutting station (S3) intersects the cutting line (47) of the first cutting station (S5) to form an obtuse angle (49).

4) A method as claimed in claim 1, wherein a reel (41), into which the web (26) is wound, is mounted on a packing machine (1) comprising the packing line (17); and the web (26) is unwound off the reel (41), is fed through a work area (42) comprising the first cutting station (S5), and is then fed to the second cutting station (S3).

5) A method as claimed in claim 4, wherein the work area (42) comprises a creasing station (S6) where the web (26) is creased along two parallel longitudinal fold lines (11); and an incision station (S7) where the web (26) is cut at the longitudinal fold lines (11) to define laterally-projecting projections (8).

6) A method as claimed in claim 4, wherein the work area (42) also comprises a printing station (S8) where a surface of the web (26) is printed.

7) A method as claimed in claim 1, wherein the web (26) is fed through the first cutting station (S5) and then wound into a reel (41); the reel (41) is then mounted on a packing machine (1) comprising the packing line (17), and the web (26) is unwound off the reel (41) and fed to the second cutting station (S3).

8) A method as claimed in claim 7, wherein, between the reel (41) and the second cutting station (S3), a work area (42) is provided comprising a creasing station (S6) where the web (26) is creased along two parallel longitudinal fold lines (11), and an incision station (S7) where the web (26) is cut at the longitudinal fold lines (11) to define laterally-projecting projections (8).

9) A method as claimed in claim 8, wherein the work area (42) also comprises a printing station (S8) where a surface of the web (26) is printed.

10) A feed unit for feeding collars to a packing line for producing rigid packages; the feed unit comprising:
a second cutting station (S3) for detaching each collar (7) from a web (26) along a transverse parting line (13, 14);
a conveying device (24) for feeding the web (26) in a longitudinal feed direction (25) and through the second cutting station (S3); and
a transfer device (28) for feeding each collar (7), detached from the web (26), to the packing line (17);
the feed unit (23) being characterized by comprising a first cutting station (S5) located upstream from the second cutting station (S3), and which receives the web (26) from the conveying device (24) to cut the web (26) along a portion (15) of each parting line (13, 14); to detach each collar (7) from the web (26), the second cutting station (S3) cuts the remaining portion (16) of the parting line (13, 14) not cut at the first cutting station (S5).

11) A feed unit as claimed in claim 10, wherein, at the first cutting station (S5), the web (26) is cut along a central portion (15) of each parting line (13, 14); and, at the second cutting station (S3), the remaining lateral portions (16) of the parting line (13, 14) not cut at the first cutting station (S5) are cut to detach each collar (7) from the web (26).

12) A feed unit as claimed in claim 11, wherein, for each parting line (13, 14), at the border area (46) between the central portion (15) cut at the first cutting station (S5) and the lateral portions (16) cut at the second cutting station (S3), the cutting line (47) of the first cutting station (S5) slopes with respect to the cutting line (48) of the second cutting station (S3), so that the cutting line (48) of the second cutting station (S3) intersects the cutting line (47) of the first cutting station (S5) to form an obtuse angle (49).

13) A feed unit as claimed in claim 10, and comprising an unwinding device (40) for unwinding the web (26) off a reel (41); and a work area (42) located upstream from the second cutting station (S3) and comprising the first cutting station (S5).

14) A feed unit as claimed in claim 13, wherein the work area (42) comprises a creasing station (S6) where the web (26) is creased along two parallel longitudinal fold lines (11); and an incision station (S7) where the web (26) is cut at the longitudinal fold lines (11) to define laterally-projecting projections (8).

15) A feed unit as claimed in claim 13, wherein the work area (42) also comprises a printing station (S8) where a surface of the web (26) is printed.

16) A web of packing material defined by a succession of collars (7) for rigid packages (2); each collar (7) is bounded by the next collar (7) along a transverse parting line (13, 14), which coincides with a top transverse edge (13) of one collar (7) and with a bottom transverse edge (14) of the next collar (7); and the web (26) of packing material is characterized in that a portion (15) of each parting line (13, 14) is cut.

17) A web of packing material as claimed in claim 16, wherein a central portion (15) of each parting line (13, 14) is cut.
